(19) United States
(12) Patent Application Publication
(10) Pub. No.: US 2010/0173554 A1
(43) Pub. Date: Jul. 8, 2010

(54) STATIC ELECTRICITY PREVENTION METHOD OF AN ORGANIC EL DISPLAY

(76) Inventor: Junhai Su, Guangdong Province (CN)

Correspondence Address: MERCHANT & GOULD PC, P.O. BOX 2903, MINNEAPOLIS, MN, 55402-0903, US

(21) Appl. No.: 12/663,216

(22) PCT Filed: Nov. 2, 2007
(86) PCT No.: PCT/CN07/03116

§ 371 Date: Dec. 4, 2009

(30) Foreign Application Priority Data
Jun. 8, 2007 (CN) 200710028497.8

(51) Int. Cl. H01J 9/00

(52) U.S. Cl. 445/24

(57) ABSTRACT

A static electricity prevention method of an organic EL display (3) comprises a static electricity prevention treatment that is performed to leads wired on the edge of a substrate glass (1) in the display (3) and exposed to external environment. An encapsulation rear cover (2) is widened at the edge of the display including the leads. The encapsulation rear cover (2) at the edge is wider than the substrate glass (1). A protection film (4) is coated to insulate the leads from external environment at the edge.

### FIELD OF THE INVENTION

The present invention relates to a static electricity prevention method of an organic electroluminescent (EL) display, and in particular to a static electricity prevention method used for an organic electroluminescent display product in the form of chip on glass (COG).

### BACKGROUND OF THE INVENTION

The organic electroluminescent display is a newly emerging flat display. It has advantages such as actively emitting light, providing a high contrast, being able to be thinned and having a high response speed. Therefore it is generally recognized as a main force of the next generation of displays. The luminescence principle of the organic electroluminescent display lies in that various functional layers including a charge injection layer, a charge transport layer and a luminescent layer are inserted between an anode and a cathode, and applying an appropriate voltage across the electrodes allows the device to emit light.

However, an electric product is easy to suffer the damage from static electricity, and the organic electroluminescent display is no exception. Measurements need to be taken to prevent static electricity damage. All the current static electricity prevention for an electronic product in design is that no power lead can be led out and exposed to the air except for the cathode and anode power leads which are led out at the edge of a glass for assembling an integrated circuit (IC). Thus, a large limit is imposed on some designs.

In mass production of organic electroluminescent displays, the displays need to be powered on for a certain period for checking when they are produced so as to get rid of the defective ones and to age those which are not defective to enhance the stability and uniformity of their performance greatly. In design of the wiring of the checking lines, the method in which only the anode and cathode leads are prolonged so as to connect the anode and cathode of a display with the checking lines can not be implemented for some products such as a COG product. This problem can be solved and the design of the display can be more flexible if leads can be provided in each direction of the display. However, if such a design is adopted, after the display is made into a separate one finally, some leads will be led to the edge of the display and accordingly exposed to the external environment, thereby easily causing static electricity damage. Therefore, a new static electricity prevention method different from the conventional ones should be adopted.

### SUMMARY OF THE INVENTION

The present invention provides a new static electricity prevention method of an organic electroluminescent display. The method requires a simple processing procedure and a low cost, and can effectively ensure the static electricity prevention effect of the display.

The object of the present invention can be achieved by the following technical solution: a static electricity prevention method of an organic electroluminescent display, performing a static electricity prevention treatment on leads wired on an edge of the display and exposed to external environment, characterized in that the method includes the steps of: widening an encapsulation rear cover at the edge of the display on which the leads are wired to be wider than a substrate glass; and coating protection glue on or attaching a protection film to the edge so as to isolate the leads from the external environment.

In the present invention, when there are leads wired on an edge of the display for assembling an integrated circuit, a flexible printed circuit is provided to cover the leads, and then the protection glue is coated on or the protection film is adhered to the edge.

The leads described in the present invention are cathode checking lines and anode checking lines of the display.

In the present invention, the encapsulation rear cover is wider than the substrate glass by 0.05˜5 mm, the protection glue is silica gel or UV glue, and the protection film is a piece of protection paper or a polymer film.

A fabricating method for static electricity prevention of an organic electroluminescent display of the present invention is characterized by including the steps of:

(1) fabricating an organic electroluminescent display device on a substrate glass;

(2) cutting and breaking the substrate glass to produce a separate display device, wherein except for a glass edge of the display for assembling an integrated circuit, encapsulation rear cover is widened to be wider than the substrate glass by 0.05˜5 mm at the position where leads are led to an edge of the substrate glass;

(3) assembling the integrated circuit;

(4) assembling a flexible printed circuit; and

(5) coating protection glue or attaching a protection film.

In the step (4), when there are cathode checking lines led out of an edge of the substrate glass for assembling the integrated circuit, the flexible printed circuit covers the leads.

In the step (5), the step of coating protection glue or attaching a protection film is executed together with the process of assembling the integrated circuit.

Compared to the related art, the present invention has the advantages as follows.

(1) The static electricity prevention method of the present invention provides a novel design in which the encapsulation rear cover is wider than the substrate glass by 0.05˜5 mm to fix the protection glue or the protection film so as to implement static electricity prevention to the display. This enables the design more flexible.

(2) The static electricity prevention method of the present invention can be implemented simultaneously with assembling the IC. This will almost not bring about any additional cost and requires a simple processing procedure.

### BRIEF DESCRIPTIONS OF THE DRAWINGS

The present invention will be described further below in conjunction with the accompanying drawings and embodiments.

FIG. 1 is a schematic diagram showing that each row of displays are connected to each other in series through checking lines;

FIG. 2 is a schematic diagram showing that each row of displays are connected to each other in parallel through checking lines;

FIG. 3 is a schematic diagram showing that separate displays are connected to a power contact block through anode and cathode checking lines;

FIG. 4 is a first schematic structure diagram of a display device adopting the novel static electricity prevention design of the present invention;

FIG. 5 is a schematic diagram showing that the anode and cathode checking lines of a display are led out of the left side and top side of the display, respectively;

FIG. 6 is a second schematic structure diagram of a display device adopting the novel static electricity prevention design of the present invention;

FIG. 7 is a schematic diagram showing that both of the anode and cathode checking lines of a display are led out of the top side of the display;

FIG. 8 is a schematic diagram showing that both of the anode and cathode checking lines of a display are led out of the left side of the display;

FIG. 9 is a third schematic structure diagram of a display device adopting the novel static electricity prevention design of the present invention;

FIG. 10 is a schematic diagram showing that the anode and cathode checking lines of a display are led out of the left side and right side of the display, respectively; and

FIG. 11 is a fourth schematic structure diagram of a display device adopting the novel static electricity prevention design of the present invention.

### DETAILED DESCRIPTION OF THE EMBODIMENTS

The embodiments of the present invention will be described in detail below in conjunction with the accompanying drawings.

### Embodiment 1

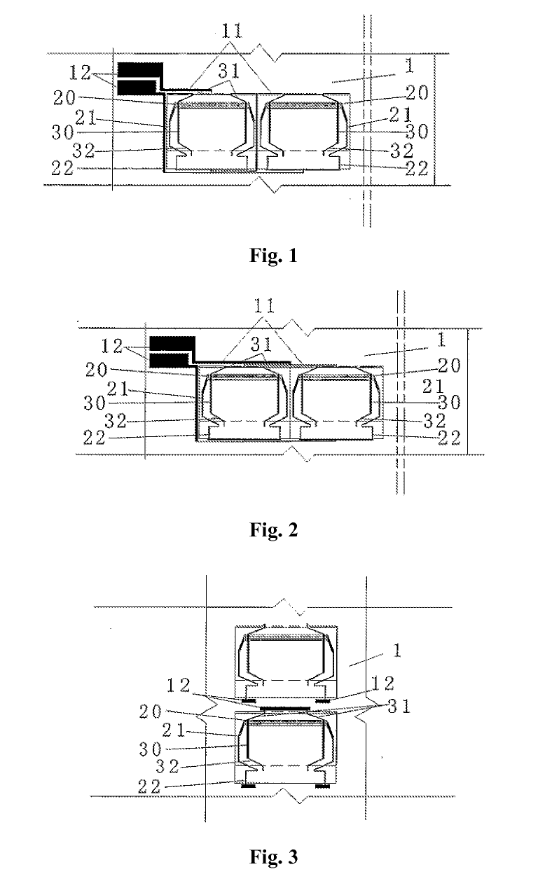

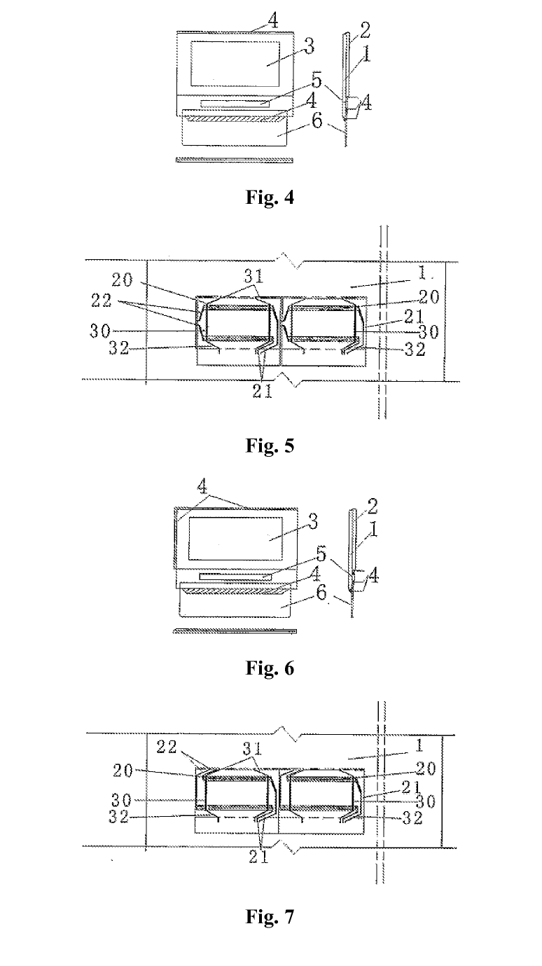

Embodiment 1 of the present invention is as shown in FIGS. 1˜4 and 7. FIGS. 1˜3 show the wiring structure of the checking lines of displays 3. All anode checking lines 31 of the displays 3 are led out of the top side of the displays 3, and all cathode checking lines 22 of the displays 3 are led out of the lead terminals of the displays 3 to be connected with checking lines 11 or with a power contact block. After the cutting and breaking into separate displays, part of these anode checking lines 31 and cathode checking lines 22 are exposed to the external environment. As shown in FIG. 4, a static electricity prevention method for the above mentioned displays 3 includes the following steps:

(1) fabricating an organic electroluminescent display 3 on a large substrate glass 1;

(2) cutting and breaking the large substrate glass to produce a separate display 3 in which except for a glass edge of the display for assembling an integrated circuit (IC) 5, an encapsulation rear cover 2 is wider than the substrate glass by 0.05˜5 mm at the position where a cathode checking line 22 and an anode checking line 31 are led to an edge of the substrate glass;

(3) assembling the IC 5;

(4) assembling a flexible printed circuit (FPC) 6; and

(5) coating protection glue 4 or attaching a protection film 4.

In the step (4), when there are cathode checking lines 31 led out of the edge of the substrate glass for assembling the IC 5, the flexible printed circuit 6 covers these leads.

In the step (5), the protection glue 4 is silica gel or UV glue, and the protection film 4 is a piece of protection paper or a polymer film. The step of coating protection glue or attaching a protection film is executed together with the existing process of assembling the IC 5. That is, the step of coating protection glue 4 on or attaching a protection film 4 to the cross section of the glass where there are anode and cathode leads led out to the edge of the substrate glass is executed immediately after the steps of assembling the IC 5 and the FPC 6. In other words, the protection glue or protection film is applied at the edge of the display where the encapsulation rear cover 2 is wider than the substrate glass 1 by 0.05˜5 mm and the FPC 6 covers the leads. Compared to the existing method for assembling the IC 5, there is almost no additional cost.

After the cutting and breaking to produce a separate display 3, there will be anode checking lines 31 for connecting the checking lines 11 of the display wired to an edge of the substrate glass 1 and part of the lines and the cross sections thereof are exposed to the external environment. In view of this, it is designed here that the encapsulation rear cover 2 is wider than the substrate glass 1 by 0.05˜5 mm, and then the protection glue or protection film 4 is applied to the position where there are the anode checking lines 31 so as to isolate the lines from the external environment. The encapsulation rear cover 2 wider than the substrate glass 1 brings about the effect of fixing the protection glue or protection film 4. After the cutting and breaking into separate displays, the cathode checking lines 22 are also exposed to the external environment. Here they are covered by the FPC 6 and then are applied with the protection glue or protection film 4 so as to be isolated from the external environment, thereby achieving the effect of static electricity prevention. Since all the design variations occur outside the display area of the display 3, they will not influence the display effect and visual effect of the display 3.

### Embodiment 2

Embodiment 2 of the present invention is as shown in FIG. 5. It is different from the previous embodiment in that besides the anode checking lines 31 of the displays 3 are led out of the top side of the displays 3, the cathode checking lines 22 are led out of the left side of the displays 3 and connected with the checking lines 11 as shown in FIGS. 1 and 2 or with the power contact block 12 as shown in FIG. 3. A schematic diagram of the static electricity prevention design for a display having the above structure is as shown in FIG. 6. In this figure, at the position where there are cathode checking lines 22 and anode checking lines 31 led out, the encapsulation rear cover 2 is designed wider than the substrate glass 1 by 0.05˜5 mm and then the protection glue or protection film 4 is applied to isolate the lines from the external environment, achieving the effect of static electricity prevention.

The cathode checking lines 22 can also be led out of the right side of the display 3, and the corresponding position where the protection glue or protection film 4 is applied for static electricity prevention is also at the right side of the display 3.

### Embodiment 3

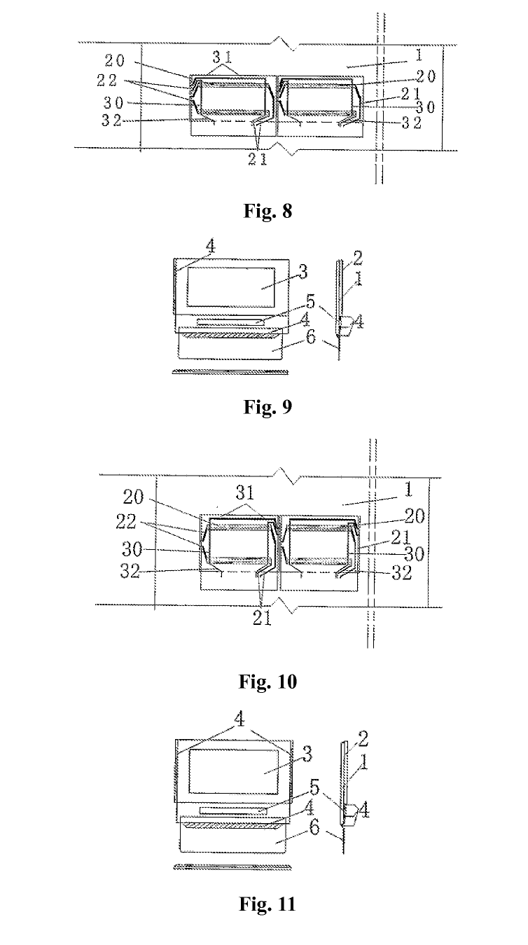

Embodiment 3 of the present invention is as shown in FIG. 8. It is different from the previous embodiment in that both the anode checking lines 31 and the cathode checking lines 22 of the displays 3 are led out of the left side (or right side) of the displays 3 and are connected with the checking lines 11 as shown in FIGS. 1 and 2 or with the power contact block 12 as shown in FIG. 3. A corresponding schematic diagram of the static electricity prevention design for a display device having such a structure is as shown in FIG. 9. In this figure, at the position where there are cathode checking lines 22 and anode checking lines 31 led out, the encapsulation rear cover 2 is designed wider than the substrate glass 1 by 0.05˜5 mm and then the protection glue or protection film 4 is applied to isolate the lines from the external environment, achieving the effect of static electricity prevention.

### Embodiment 4

Embodiment 4 of the present invention is as shown in FIG. 10. It is different from the previous embodiment in that in FIG. 10, the anode checking lines 31 are led out of the right side of the displays 3 and the cathode checking lines 22 are led out of the left side of the displays 3, and are connected with the checking lines 11 as shown in FIGS. 1 and 2 or with the power contact block 12 as shown in FIG. 3. Of course, here the anode checking lines 31 can be led out of both the right and left sides of the displays 3 and the cathode checking lines 22 can be led out of one side (left or right side) of the displays 3. A corresponding schematic diagram of the static electricity prevention design for a display with such a structure is as shown in FIG. 11. In this figure, at the position where there are cathode checking lines 22 and anode checking lines 31 led out of both sides of the display 3, the encapsulation rear cover 2 is designed wider than the substrate glass 1 by 0.05˜5 mm and then the protection glue or protection film 4 is applied to isolate the lines from the external environment, achieving the effect of static electricity prevention.

1. A static electricity prevention method of an organic electroluminescent display, performing a static electricity prevention treatment on leads wired on an edge of the display and exposed to external environment, characterized in that the method comprises the steps of: widening an encapsulation rear cover at the edge of the display on which the leads are wired to be wider than a substrate glass; and coating protection glue on or attaching a protection film to the edge so as to isolate the leads from the external environment.

2. The method according to claim 1, wherein when there are leads wired on an edge of the display for assembling an integrated circuit, a flexible printed circuit is provided to cover the leads, and then the protection glue is coated on or the protection film is adhered to the edge.

3. The method according to claim 1, wherein the leads are anode checking lines and cathode checking lines of the display.

4. The method according to claim 1, wherein the encapsulation rear cover is wider than the substrate glass by 0.05˜5 mm.

5. The method according to claim 1, wherein the protection glue is silica gel or UV glue, and the protection film is a piece of protection paper or a polymer film.

6. A fabricating method for static electricity prevention of an organic electroluminescent display according to claim 1, comprising the steps of:
(1) fabricating an organic electroluminescent display device on a substrate glass;
(2) cutting and breaking the substrate glass to produce a separate display device, wherein except for a glass edge of the display for assembling an integrated circuit, encapsulation rear cover is widened to be wider than the substrate glass by 0.05˜5 mm at the position where leads are led to an edge of the substrate glass;
(3) assembling the integrated circuit;
(4) assembling a flexible printed circuit; and
(5) coating protection glue or attaching a protection film.

7. The method according to claim 6, wherein in the step (4), when there are cathode checking lines led out of an edge of the substrate glass for assembling the integrated circuit, the flexible printed circuit covers the leads.

8. The method according to claim 6, wherein in the step (5), the step of coating protection glue or attaching a protection film is executed together with the process of assembling the integrated circuit.

9. The method according to claim 2, wherein the leads are anode checking lines and cathode checking lines of the display.

10. The method according to claim 2, wherein the protection glue is silica gel or UV glue, and the protection film is a piece of protection paper or a polymer film.

11. A fabricating method for static electricity prevention of an organic electroluminescent display according to claim 2, comprising the steps of:
(1) fabricating an organic electroluminescent display device on a substrate glass;
(2) cutting and breaking the substrate glass to produce a separate display device, wherein except for a glass edge of the display for assembling an integrated circuit, encapsulation rear cover is widened to be wider than the substrate glass by 0.05˜5 mm at the position where leads are led to an edge of the substrate glass;
(3) assembling the integrated circuit;
(4) assembling a flexible printed circuit; and
(5) coating protection glue or attaching a protection film.

12. The method according to claim 11, wherein in the step (4), when there are cathode checking lines led out of an edge of the substrate glass for assembling the integrated circuit, the flexible printed circuit covers the leads.

13. The method according to claim 11, wherein in the step (5), the step of coating protection glue or attaching a protection film is executed together with the process of assembling the integrated circuit.
